(19) United States
(12) Patent Application Publication
(10) Pub. No.: US 2025/0076893 A1
(43) Pub. Date: Mar. 6, 2025

(54) METHOD AND DEVICE FOR OPTIMIZING A CLIMB PHASE OF AN AIRCRAFT, IN PARTICULAR IN TERMS OF FUEL CONSUMPTION

(71) Applicant: Airbus Operations (S.A.S.), Toulouse (FR)

(72) Inventor: Luiz Pradines de Menezes Junior, Toulouse (FR)

(73) Assignee: Airbus Operations (S.A.S.), Toulouse (FR)

(21) Appl. No.: 18/815,189

(22) Filed: Aug. 26, 2024

(30) Foreign Application Priority Data
Aug. 28, 2023 (FR) 2308989

(51) Int. Cl. G05D 1/644

(52) U.S. Cl. CPC G05D 1/644

(57) ABSTRACT

A method for optimizing a climb phase of an aircraft, implemented repeatedly during the climb phase, includes an acquiring step for acquiring current values of input parameters, a determining step for determining a current optimized DT_{flex} value from the current values of the input parameters and from optimized DT_{flex} values recorded in a database and a transmitting step for transmitting the determined current optimized DT_{flex} value to a user system with a view to controlling the thrust of the aircraft, the method making it possible to continuously adapt, during the climb phase, the optimized DT_{flex} value so it corresponds to current conditions of the aircraft to maximize its performance particular for fuel consumption.

### TECHNICAL FIELD

The disclosure herein relates to a device and a method for optimizing a climb phase of an aircraft, for example a cargo plane, in particular in terms of fuel consumption.

### BACKGROUND

The engines of an aircraft are subject to high stresses when operating at very high engine speeds, i.e. when generating close to the maximum available thrust. This is in particular the case in phases associated with take-off and climb-out, during which substantial thrust is required. These stresses are caused by exhaust gases of high temperature, which is generated at high engine speeds. It would therefore be desirable to limit, as far as possible, use of the maximum available thrust in order to spare the engines, limit their maintenance costs and increase their lifespan.

A number of methods are known that allow thrust to be limited during phases associated with take-off and climb-out of an aircraft such as a cargo plane.

For example, one conventional method consists in using a predefined thrust limit during take-off. The aircraft then takes off using a certain set percentage of its maximum available thrust up to a predetermined altitude, then continues its climb with the usual thrust. However, use of a set thrust limit is not suitable for a wide range of take-off weights.

Another method, called the “autoderate” method or the “flex-temp” method (flex-temp standing for flexible temperature), which is implemented by the flight management system (FMS) of the aircraft, consists in computing a fictitious temperature (called the flex temperature) to be taken into account by the systems of the aircraft instead of the actual ambient temperature. Specifically, the available thrust of an aircraft depends on ambient temperature. Above a certain temperature, the higher the ambient temperature, the lower the maximum available thrust. Thus, where possible, a fictitious temperature higher than the actual ambient temperature is computed based on certain characteristics (the weight of the aircraft, the altitude that it is desired to reach, a reference ambient temperature, etc.) and used so as to allow the aircraft to take off with a reduced thrust. Although this method creates flexibility in that it allows the required reduced thrust applied during take-off to be chosen, in particular depending on the weight of the aircraft, it results in use of a constant flex temperature, which is not the most suitable at every point during the climb phase.

In any case, these known methods are sub-optimal in terms of cost, and in particular in terms of fuel consumption. Specifically, they result in use of thrust that is sometimes ineffective during the climb phase, this leading to excess fuel consumption.

The known solutions are therefore not completely satisfactory.

### SUMMARY

The aim of the disclosure herein is to rectify the above-mentioned drawbacks. It relates to a method for optimizing a climb phase of an aircraft comprising determining an optimized DT_{flex} value corresponding to a temperature differential used to control the thrust of the aircraft.

According to the disclosure herein, the method comprises at least the following sequence of steps implemented by an avionic computer repeatedly during the climb phase:
an acquiring step for acquiring current values of input parameters including at least the weight of the aircraft, the speed of the aircraft, the altitude of the aircraft and a reference temperature;
a determining step for determining a current optimized DT_{flex} value from the current values of the input parameters acquired in the acquiring step and from optimized DT_{flex} values recorded in a database integrated into the avionic computer, the database having been created beforehand by associating an optimized DT_{flex} value with each combination of input parameters for a predefined number of combinations of input parameters; and
a transmitting step for transmitting the current optimized DT_{flex} value determined in the determining step to a user system capable of using the current optimized DT_{flex} value to control the thrust of the aircraft.

Thus, by virtue of the disclosure herein, it is possible to continuously adapt, during the climb phase, the optimized DT_{flex} value so that it corresponds to the current conditions of the aircraft. This adaptation makes it possible to modulate the thrust of the aircraft so as to maximize its performance in terms of costs, and in particular in terms of fuel consumption.

In addition, in an embodiment, the method comprises a preliminary step implementing a creating method to create the database, the preliminary step comprising a set of sub-steps implemented for each of the combinations of input parameters and comprising:
a first computing sub-step for computing sets of climb parameters characterizing the climb phase of the aircraft with the input parameters in question, the climb parameters comprising at least a fuel flow rate of the aircraft, a net thrust of the aircraft and a drag of the aircraft, a set of climb parameters being computed for each DT_{flex} value among a predefined number of DT_{flex} values;
a second computing sub-step for computing at least one value representing the cost of the climb phase for each set of climb parameters computed in the first computing sub-step; and
a selecting sub-step for selecting the DT_{flex} value for which the cost of the climb phase is minimal and for recording this DT_{flex} value in the database as the optimized DT_{flex} value associated with the combination of input parameters in question.

Advantageously, the value representing the cost of the climb phase is computed with the following mathematical formula:

$$J = \frac{1}{\dot{E}} \cdot ( FF - {λ}_{ref} \cdot V )$$

in which:
[symbol] is a specific energy of the aircraft;
FF is the fuel flow rate of the aircraft;
λ_{ref} is a reference factor; and
V is the speed of the aircraft.

In addition, in the first computing sub-step, the DT_{flex} values for which a set of climb parameters is computed are comprised between a minimum DT_{flex} value and a maximum DT_{flex} value, the minimum DT_{flex} value corresponding to a DT_{flex} value for which thrust is maximum and the maximum DT_{flex} value corresponding to a DT_{flex} value for which the climb rate of the aircraft is equal to a predefined minimum climb rate.

In an embodiment, the method comprises a verifying step, implemented after the determining step, for:
determining a theoretical value of the exhaust-gas temperature of the aircraft that should be obtained with the current optimized DT_{flex} value determined in the determining step, based on predetermined exhaust-gas-temperature values;
comparing the theoretical value of the exhaust-gas temperature with a limit value of the exhaust-gas temperature; and
if the theoretical value of the exhaust-gas temperature is lower than or equal to the limit value of the exhaust-gas temperature, transmitting the current optimized DT_{flex} value in the transmitting step; and
if the theoretical value of the exhaust-gas temperature is higher than the limit value of the exhaust-gas temperature, transmitting the DT_{flex} value for which the theoretical value of the exhaust-gas temperature is equal to the limit value of the exhaust-gas temperature as current optimized DT_{flex} value in the transmitting step.

Moreover, in another embodiment, the method comprises a measuring step, implemented before the acquiring step, for measuring the current values of the input parameters and for transmitting the current values of the input parameters to the avionic computer.

The disclosure herein also relates to a device for optimizing a climb phase of an aircraft for determining an optimized DT_{flex} value corresponding to a temperature differential used to control the thrust of the aircraft.

According to the disclosure herein, the device comprises at least one avionic computer configured to:
acquire current values of input parameters including at least the weight of the aircraft, the speed of the aircraft, the altitude of the aircraft and a reference temperature;
determine a current optimized DT_{flex} value from the current values of the input parameters acquired in the acquiring step and from optimized DT_{flex} values recorded in a database integrated into the avionic computer, the database having been created beforehand by associating an optimized DT_{flex} value with each combination of input parameters for a predefined number of combinations of input parameters; and
transmit the current optimized DT_{flex} value determined in the determining step to a user system capable of using the current optimized DT_{flex} value to control the thrust of the aircraft.

### BRIEF DESCRIPTION OF THE DRAWINGS

The appended figures will make it easy to understand how the disclosure herein may be implemented. In these figures, identical reference signs denote similar elements.

FIG. 1 is a schematic perspective view of an aircraft comprising a device for optimizing a climb phase.

FIG. 2 is a block diagram of a method for optimizing a climb phase.

FIG. 3 is a schematic illustrating a method for creating a database

containing optimized DT_{flex} values associated with combinations of input parameters.

FIG. 4 is a graph illustrating one example of some of the information contained in a database created by the method of FIG. 3.

FIG. 5 is a graph illustrating one example of an advantageous effect of the method for optimizing a climb phase on the speed of rotation of the blades of an aircraft engine, with respect to a conventional method.

FIG. 6 is a graph illustrating one example of an advantageous effect of the method for optimizing a climb phase on the exhaust-gas temperature of an aircraft engine, with respect to a conventional method.

### DETAILED DESCRIPTION

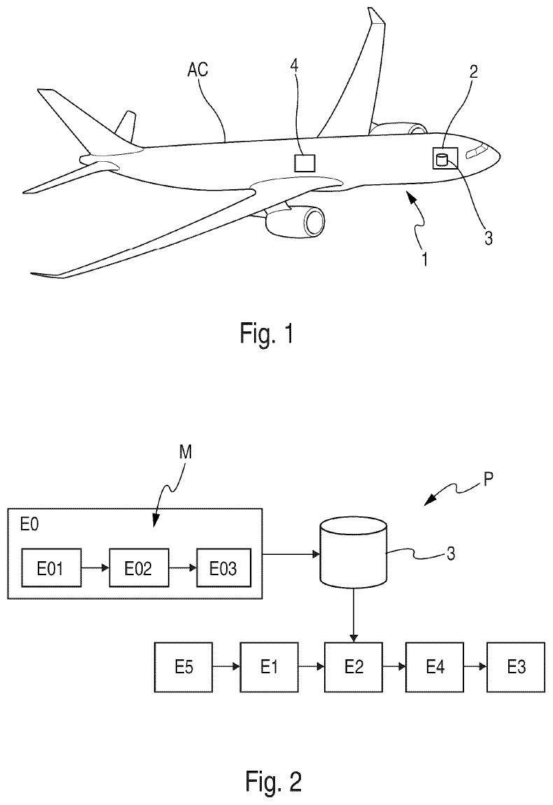

A device for optimizing a climb phase of an aircraft AC (referred to as the device 1 below) allowing the disclosure herein to be illustrated has been schematically shown in FIG. 1. This device 1, with which the aircraft AC is equipped, makes it possible to determine an optimized DT_{flex} value, which is intended to be used to control the thrust of the aircraft AC during the climb phase.

In the context of the disclosure herein, and for the sake of simplicity, what is meant by “climb phase” is a flight phase of the aircraft AC comprising a take-off from a runway of an airport and a phase of ascent during which the aircraft AC gains altitude (generally from 1500 feet) to reach a desired altitude called the TOC altitude (TOC standing for Top of Climb).

Moreover, the DT_{flex} value corresponds to a conventional temperature differential allowing a setpoint to be generated with a view to controlling the thrust of the aircraft AC. More precisely, the DT_{flex} value corresponds to the difference between a reference temperature representing the actual ambient temperature and a fictitious temperature (called the flex temperature) representing the temperature that it is desired to use as ambient temperature when generating the setpoint used to control the thrust of the aircraft AC. This setpoint is used to control the propulsion system of the aircraft AC, which comprises at least one engine, a turbofan engine for example.

The reference temperature is given by the ISA model (ISA standing for International Standard Atmosphere), which defines standard temperatures and pressures allowing variations due to geographical position and altitude to be avoided.

The flex temperature is chosen so as to respect a minimum climb rate, namely a vertical speed allowing the aircraft AC to reach the TOC altitude within a desired time. Thus, depending on the climb phase, a plurality of DT_{flex} values may be considered.

The objective of the device 1 is to determine, continuously during the climb phase, the DT_{flex} value for which the cost of the climb phase is minimal.

To do this, the device 1 comprises an avionic computer 2 mounted on the aircraft AC and configured to determine a current optimized DT_{flex} value, namely a DT_{flex} value making it possible to obtain an optimal aircraft performance during the climb phase. The optimized DT_{flex} value is the to be current because it is determined depending on current parameters of the aircraft AC, as detailed below.

In the context of the disclosure herein, the performance of the aircraft AC is considered to be optimal when the cost of the climb phase is minimal. Depending on the embodiment in question, the cost of the climb phase may comprise a number of components. Preferably, it is a question of fuel consumption during the climb phase. However, the cost may also take into account other criteria such as the time required to reach the TOC altitude.

Moreover, the avionic computer 2 preferably corresponds to a flight management system (FMS).

In a preferred embodiment, the avionic computer 2 is configured to carry out the operations described below repeatedly throughout the climb phase.

To do this, the avionic computer 2 is configured to acquire current values of input parameters characterizing the current situation of the aircraft AC. The input parameters comprise at least the following parameters: the weight of the aircraft AC, the speed of the aircraft AC, the altitude of the aircraft AC and the reference temperature.

Certain input parameters are intended to vary over the course of the climb phase. Their current value must therefore be measured repeatedly during the climb phase. Other input parameters may be predefined constants. In this case, their value is stored in a memory so as to be accessible to the avionic computer 2.

In an embodiment, the device 1 comprises conventional measuring systems or apparatuses with which the aircraft AC is equipped and which are capable of measuring, in a conventional way, the current values of the input parameters. These systems or apparatuses are also capable of transmitting the measured current values to the avionic computer 2.

In addition, the avionic computer 2 is configured to determine a current optimized DT_{flex} value from the current values of the input parameters and from optimized DT_{flex} values stored in a database 3.

Preferably, the database 3 is integrated into the avionic computer 2. It contains optimized DT_{flex} values, each of which is associated with a particular combination of input parameters.

The database 3 is created beforehand by recording optimized DT_{flex} values for a predefined number of combinations of input parameters. A method for creating the database 3 will be described in more detail in the remainder of the description.

Furthermore, the avionic computer 2 is configured to transmit the current optimized DT_{flex} value to a user system 4 capable of using the current optimized DT_{flex} value to control the thrust of the aircraft AC. It may be a question of a conventional unit of the aircraft AC, configured to control the propulsion systems of the aircraft AC. For example, the user system 4 may correspond to a FADEC system (FADEC standing for Full Authority Digital Engine Control).

The user system 4 is intended to use the current optimized DT_{flex} value to determine a setpoint for the propulsion systems of the aircraft AC during the climb phase. The optimized DT_{flex} value transmitted by the avionic computer 2 is continuously updated throughout the climb phase so as to constantly take account of the variation in the input parameters. In this way, the thrust setpoint of the aircraft AC is constantly adjusted with the current optimized DT_{flex} value.

Thus, by virtue of the device 1, it is possible to continuously adapt, during the climb phase, the optimized DT_{flex} value so that it corresponds to the current conditions of the aircraft AC. This adaptation makes it possible to modulate the thrust of the aircraft AC so as to maximize its performance in terms of costs, and in particular in terms of fuel consumption.

The device 1 such as described above is configured to implement a method P, an embodiment of which is schematically shown in FIG. 2. In this embodiment, the method P comprises a sequence of steps E1, E2 and E3 that are implemented repeatedly by the avionic computer 2 during the climb phase.

More precisely, in step E1 the current values of the input parameters are acquired.

In addition, in step E2 the current optimized DT_{flex} value is determined from the current values of the input parameters acquired in step E1 and from the optimized DT_{flex} values recorded in the database 3.

Furthermore, in step E3 the current optimized DT_{flex} value determined in step E2 is transmitted to the user system 4 capable of using the current optimized DT_{flex} value to control the thrust of the aircraft AC.

In an embodiment, the method P is also capable of implementing a method M for creating the database 3. In this embodiment, which is shown in FIG. 2, the method P thus comprises a preliminary step E0 carried out before the sequence of steps E1, E2 and E3. Step E0 employs the method M to create the database 3.

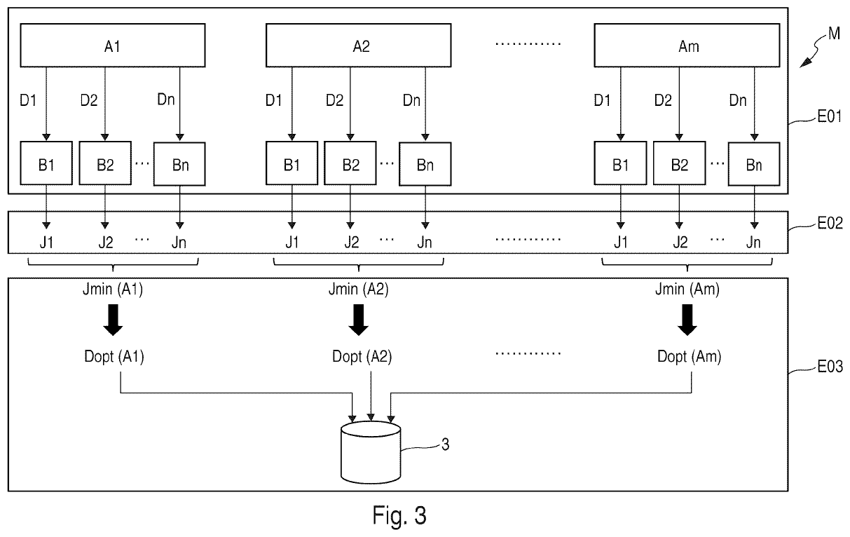

The method M, which has been schematically shown in FIG. 3, comprises a sequence of sub-steps E01, E02 and E03 for creating the database 3. The method M consists, for a predefined number of combinations of input parameters, in associating an optimized DT_{flex} value with each of the combinations of input parameters.

Specifically, for a given combination of input parameters and a given climb phase, it is possible to determine, analytically, the thrust sufficient to reach the TOC altitude with a minimal cost. This computation may be carried out in a conventional way, in particular using the specific-energy method and optimal control theory. It is then possible to deduce the DT_{flex} value allowing this sufficient thrust to be obtained. This is the optimized DT_{flex} value associated with the combination of input parameters in question.

As shown in FIG. 3, the combinations of input parameters with which it is desired to associate optimized DT_{flex} values are denoted (A1, A2, . . . , Am), m being a positive integer corresponding to the predefined number of combinations of input parameters.

In sub-step E01 sets of climb parameters characterizing the climb phase of the aircraft AC with the input parameters in question are computed. The climb parameters comprise at least the fuel flow rate of the aircraft AC, the net thrust of the aircraft AC and the drag of the aircraft AC. For each combination of input parameters (A1, A2, . . . , Am), in sub-step E01 a plurality of sets of climb parameters is computed. As shown in FIG. 3, the sets of climb parameters are denoted (B1, B2, . . . , Bn), n being a positive integer corresponding to the number of sets of climb parameters computed per combination of input parameters.

Each set of climb parameters (B1, B2, . . . , Bn) corresponds to the climb parameters obtained for a particular DT_{flex} value. Specifically, for a given combination of input parameters, there are a plurality of possible DT_{flex} values that make it possible to achieve the minimum climb rate to be respected in the climb phase. As shown in FIG. 3, the DT_{flex} values for which the sets of climb parameters (B1, B2, . . . , Bn) are computed are denoted (D1, D2, . . . , Dn), respectively.

The number n of sets of climb parameters computed per combination of input parameters corresponds to the number of possible DT_{flex} values that it is desired to take into account. Possible DT_{flex} values are comprised between a minimum DT_{flex} value and a maximum DT_{flex} value. Preferably, the minimum DT_{flex} value corresponds to zero, namely the DT_{flex} value for which a maximum thrust is obtained, and the maximum DT_{flex} value corresponds to the DT_{flex} value for which a thrust generating the minimum climb rate to be respected in the climb phase is obtained.

By way of illustrative example, for a given combination of input parameters, the possible DT_{flex} values may be between 10° C. (maximum thrust) and 30° C. (thrust generating the minimum climb rate to be respected). Among these possible DT_{flex} values, it is possible to choose to compute climb parameters every degree Celsius. This represents the computation of thirty-one sets of parameters (in this case m=31).

Furthermore, in sub-step E02 a cost value representing the cost of the climb phase is computed for each set of climb parameters (B1, B2, . . . , Bn) computed in sub-step E01. As shown in FIG. 3, the cost values computed for the sets of climb parameters (B1, B2, . . . , Bn) are denoted (J1, J2, . . . , Jn), respectively.

In one preferred embodiment, the cost value, for a given set of climb parameters, is computed with the following mathematical formula:

$$J = \frac{1}{\dot{E}} \cdot ( FF - {λ}_{ref} \cdot V )$$

in which:
[symbol] is a specific energy of the aircraft AC;
FF is the fuel flow rate of the aircraft AC;
λ_{ref} is a reference factor; and
V is the speed of the aircraft AC.

The reference factor λ_{ref} corresponds to a ratio between a reference fuel flow rate and a reference speed. These parameters represent ideal flight conditions for the aircraft AC, i.e. conditions that generate minimal cost. The reference factor λ_{ref} serves as a point of comparison to quantify the cost difference between the current flight conditions of the aircraft AC and the ideal flight conditions (in general the conditions that it is sought to obtain in the cruise phase).

Moreover, the specific energy E of the aircraft AC may be computed with the following mathematical formula:

$$\dot{E} = V \cdot ( \frac{{F}_{N} - D}{m} )$$

in which:
V is the speed of the aircraft AC;
F_{N} is the net thrust of the aircraft AC;
D is the drag of the aircraft AC; and
m is the weight of the aircraft AC.

Furthermore, in sub-step E03, for each combination of input parameters (A1, A2, . . . Am), the DT_{flex} value for which the cost of the climb phase is minimal is selected. Each of the selected DT_{flex} values is specific to one combination of input parameters. As shown in FIG. 3, the selected DT_{flex} values are denoted Dopt(A1), Dopt(A2), . . . , Dopt(Am). They are each recorded in the database 3 as being, each time, the optimized DT_{flex} value associated with the combination of input parameters that is specific thereto.

In the preferred embodiment described above, the selected DT_{flex} values Dopt(A1), Dopt(A2), . . . , Dopt(Am) to be recorded in the database 3 correspond to the DT_{flex} values for which the cost value (J1, J2, . . . , Jn) is lowest. As shown in FIG. 3, the lowest cost value for each combination of input parameters (A1, A2, . . . , Am) is denoted (Jmin(A1), Jmin(A2), . . . , Jmin(Am)), respectively.

Thus, the method M makes it possible to create the database 3 containing a multitude of optimized DT_{flex} values, each associated with one combination of input parameters. The higher the number of combinations of input parameters taken into account to create the database 3, the more able it will be to provide an optimized DT_{flex} value in a variety of situations.

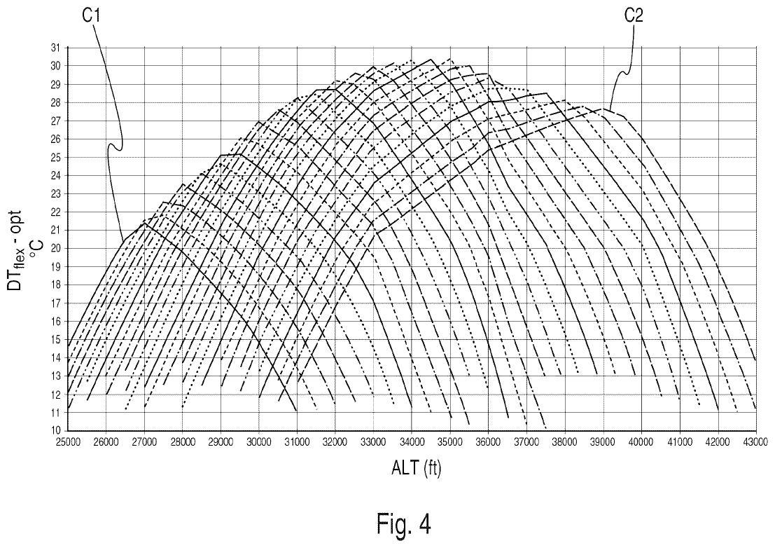

One example illustrating part of the database 3 is shown in FIG. 4. This part of the database 3 has been presented in the form of a graph containing a plurality of curves, each representing optimized DT_{flex} values as a function of the altitude of the aircraft AC for a particular aircraft weight. In FIG. 4, the y-axis, denoted “DT_{flex}-opt”, gives the optimized DT_{flex} value expressed in degrees Celsius (° C.). The x-axis, denoted “ALT”, gives the aircraft altitude expressed in feet (ft).

Furthermore, FIG. 4 contains optimized DT_{flex} values for a particular reference temperature and a particular speed of the aircraft AC. Thus, it will be understood that this graph depicts some of the information in the database 3. The latter contains a multitude of optimized DT_{flex} values for a high number of combinations of input parameters. This multitude of optimized DT_{flex} values makes it possible to cover a high number of possible situations but also to determine a DT_{flex} value corresponding precisely to a particular situation.

By way of example, the graph of FIG. 4 contains twenty-eight curves representing optimized DT_{flex} values for aircraft weights between 300 tonnes (curve denoted C1) and 570 tonnes (curve denoted C2). The mass interval between two curves is therefore 10 tonnes. Thus, the database 3 makes it possible to give the optimized DT_{flex} value with an accuracy of 10 tonnes for this input parameter, namely the weight of the aircraft AC.

In an embodiment, shown in FIG. 2, the method P also comprises a verifying step E4 implemented after step E2 but before step E3. Step E4 makes it possible to verify whether or not the current optimized DT_{flex} value, determined in step E2, generates an exhaust-gas temperature (EGT) that exceeds a predefined limit.

To do this, step E4 determines a theoretical value of the exhaust-gas temperature that should be obtained with the current optimized DT_{flex} value determined in step E3. This theoretical value is determined based on predetermined exhaust-gas-temperature values. Specifically, depending on the characteristics of the propulsion systems of an aircraft, it is possible to deduce the exhaust-gas temperature generated for a given thrust. Thus, it is possible to provide predetermined values of exhaust-gas temperature depending on the thrust used. These predetermined values may be recorded so as to be accessible to the avionic computer 2, for example in the database 3 or in another memory provided for this purpose.

Next, in step E4 this theoretical value of the exhaust-gas temperature is compared with a limit value of the exhaust-gas temperature. This limit value corresponds to the exhaust-gas-temperature value that it is not desired to exceed. It may be defined depending on characteristics of the propulsion systems of the aircraft AC and corresponds to a temperature above which there is considered to exist an increase in the stresses on the engines liable to increase their maintenance cost and/or reduce their lifespan.

Furthermore, in step E4 the current optimized DT_{flex} value determined in step E2 is transmitted or is not transmitted to step E3 depending on the result of the aforementioned comparison.

If the theoretical value of the exhaust-gas temperature is lower than or equal to the limit value of the exhaust-gas temperature, then the current optimized DT_{flex} value determined in step E2 is transmitted to step E3.

If the theoretical value of the exhaust-gas temperature is higher than the limit value of the exhaust-gas temperature, then the current optimized DT_{flex} value transmitted to step E3 is not the one determined in step E2. The DT_{flex} value that is transmitted to step E3 is the DT_{flex} value for which the theoretical value of the exhaust-gas temperature is equal to the limit value of the exhaust-gas temperature.

Thus, in the case where the current optimized DT_{flex} value determined in step E2 generates too great an exhaust-gas temperature, a compromise is made. As explained above, another DT_{flex} value (which is higher than the optimized DT_{flex} value determined in step E2) is then used as the current optimized DT_{flex} value so that the exhaust-gas temperature does not exceed the predefined limit value. This makes it possible to keep cost as low as possible. Specifically, the shortfall in terms of fuel consumption is offset by the gain in terms of maintenance cost and of lifespan of the engines.

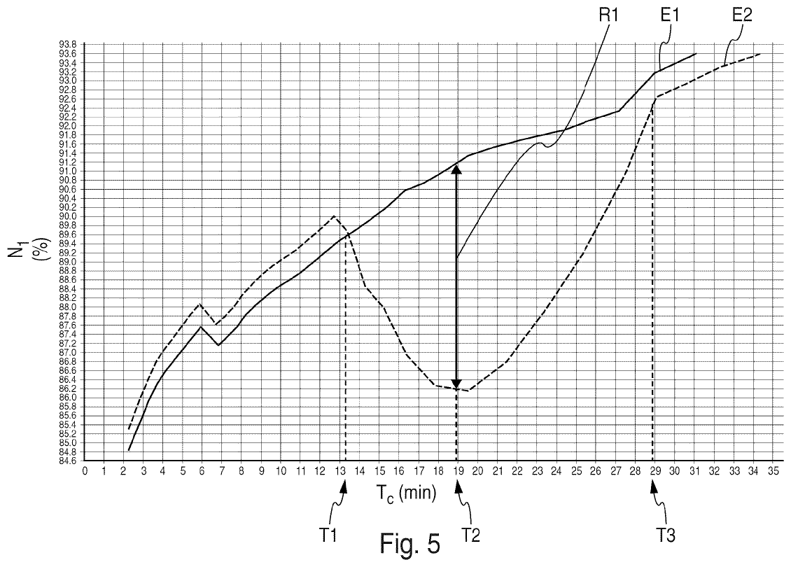

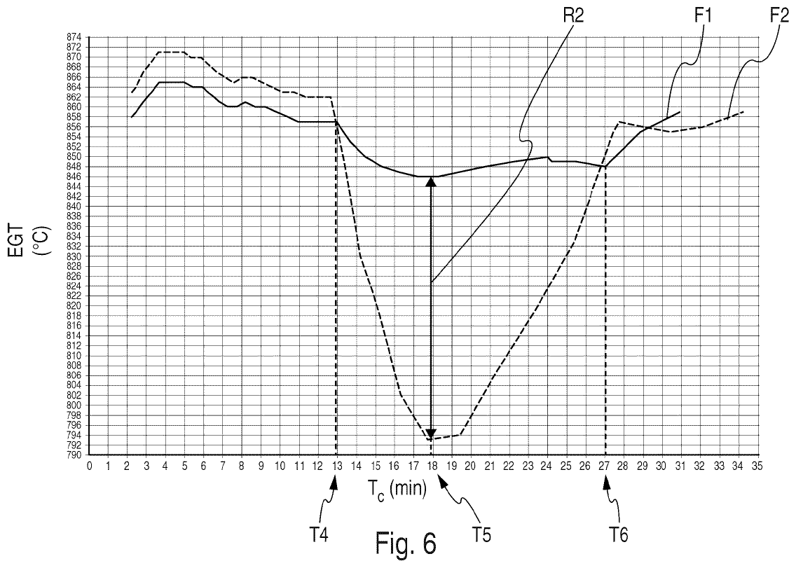

Non-limitingly, examples of advantageous effects obtained by virtue of the device 1 implementing the method P have been shown in FIG. 5 and FIG. 6. N.B., these examples relate to an aircraft with a weight equal to 560 tonnes.

FIG. 5 is a graph showing the speed of rotation of the engine blades of an aircraft during a climb phase as a function of flight time. The y-axis, denoted N₁, represents the speed of rotation of the blades expressed as a percentage of the maximum speed of rotation of the blades. The x-axis, denoted T_{c}, represents the flight time during the climb phase expressed in minutes, zero designating the start of the climb phase.

FIG. 5 contains two curves E1 and E2. Curve E1 represents the speed of rotation of the engine blades of an aircraft using a conventional method for managing thrust. Curve E2 represents the speed of rotation of the engine blades of an aircraft using the method P. It will be noted that curve E1 increases continuously throughout the climb phase. In contrast, curve E2 increases until a time T1 (at about 13 min), then decreases until a time T2 (at about 19 min) before rising again until the end of the climb phase. Curve E2 rejoins curve E1 after a time T3 (at about 28 min), the speeds of rotation of the blades of the two curves being substantially identical from the time T3.

Although the speed of rotation of the blades obtained using the method P is slightly higher than the speed of rotation obtained with a conventional method before the time T1 (because a rapid climb was chosen), it remains much lower during the rest of the climb phase.

Thus, the method P makes it possible to reduce the speed of rotation of the blades during the climb phase, with respect to a conventional method. In the example of FIG. 5, the speed of rotation of the blades is reduced between times T1 and T3, this representing a reduction for a time of sixteen minutes over a climb phase lasting about thirty minutes. In addition, it will be noted that at the peak of the reduction, at the time T2, the speed of rotation of the blades is about 91% for curve E1 and 86% for curve E2. A maximum reduction, denoted R₁, of the order of 5% is thus obtained.

Moreover, FIG. 6 is a graph showing the exhaust-gas temperature of an aircraft during a climb phase as a function of flight time. The y-axis, denoted EGT, represents exhaust-gas temperature expressed in degrees Celsius. The x-axis, denoted To, represents the flight time during the climb phase expressed in minutes, zero designating the start of the climb phase.

FIG. 6 contains two curves F1 and F2. Curve F1 represents the exhaust-gas temperature of an aircraft using a conventional method for managing thrust. Curve F2 represents the exhaust-gas temperature of an aircraft using the method P. It will be noted that curve F1 remains relatively constant throughout the climb phase, at around a value equal to 850° C. In contrast, curve F2 is relatively constant at around 850° C. until a time T4 (at about 13 min), then decreases until a time T5 (at about 18 min) before increasing until a time T6 (at about 27 min) from which it effectively rejoins curve F2.

Thus, the method P also makes it possible to reduce exhaust-gas temperature during the climb phase, with respect to a conventional method. In the example in FIG. 6, the exhaust-gas temperature is reduced between times T4 and T6, this representing a reduction during a time of about fourteen minutes over a climb phase lasting about thirty minutes. In addition, it will be noted that at the peak of the reduction, at the time T5, the exhaust-gas temperature of the curve F2 is about 790° C. A maximum reduction, denoted R₂, of the order of 60° C. is therefore obtained, with respect to the exhaust-gas temperature generated with a conventional method.

N.B., in the example considered above, the method P allows about 73 kg of fuel to be saved, with respect to a conventional climb phase. Of course, this gain varies depending on the aircraft and on the flight conditions in question.

The device 1 implementing the method P such as described above has many advantages. In particular:
it allows the cost of the climb phase to be minimized, particularly in terms of fuel consumption;
it is suitable for implementation in a wide variety of climb-phase configurations; and
it is simple and inexpensive to implement.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for optimizing a climb phase of an aircraft comprising determining an optimized DT_{flex} value corresponding to a temperature differential used to control thrust of the aircraft, the method comprising at least a sequence of steps implemented by an avionic computer repeatedly during the climb phase of:
an acquiring step for acquiring current values of input parameters including at least a weight of the aircraft, a speed of the aircraft, an altitude of the aircraft and a reference temperature;
a determining step for determining a current optimized DT_{flex} value from the current values of the input parameters acquired in the acquiring step and from optimized DT_{flex} values recorded in a database integrated into the avionic computer, the database having been created beforehand by associating an optimized DT_{flex} value with each combination of input parameters for a predefined number of combinations of input parameters; and
a transmitting step for transmitting the current optimized DT_{flex} value determined in the determining step to a user system capable of using the current optimized DT_{flex} value to control the thrust of the aircraft.

2. The method of claim 1, comprising a preliminary step implementing a creating method to create the database, the preliminary step comprising a set of sub-steps implemented for each of the combinations of input parameters and comprising:
a first computing sub-step for computing sets of climb parameters characterizing the climb phase of the aircraft with the input parameters in question, the climb parameters comprising at least a fuel flow rate of the aircraft, a net thrust of the aircraft and a drag of the aircraft, a set of climb parameters being computed for each DT_{flex} value among a predefined number of DT_{flex} values;
a second computing sub-step for computing at least one value representing a cost of the climb phase for each set of climb parameters computed in the first computing sub-step; and
a selecting sub-step for selecting the DT_{flex} value for which the cost of the climb phase is minimal and for recording the DT_{flex} value in the database as the optimized DT_{flex} value associated with the combination of input parameters in question.

3. The method of claim 2, wherein a value J representing the cost of the climb phase is computed with a following mathematical formula:
$$J = \frac{1}{\dot{E}} \cdot ( FF - {λ}_{ref} \cdot V )$$
in which: [symbol]
is a specific energy of the aircraft;
FF is the fuel flow rate of the aircraft;
λ_{ref} is a reference factor; and
V is the speed of the aircraft.

4. The method of claim 2, wherein in the first computing sub-step, the DT_{flex} values for which a set of climb parameters is computed are comprised between a minimum DT_{flex} value and a maximum DT_{flex} value, the minimum DT_{flex} value corresponding to a DT_{flex} value for which thrust is maximum and the maximum DT_{flex} value corresponding to a DT_{flex} value for which the climb rate of the aircraft is equal to a predefined minimum climb rate.

5. The method of claim 1, comprising a verifying step, implemented after the determining step, for:
determining a theoretical value of an exhaust-gas temperature of the aircraft that should be obtained with the current optimized DT_{flex} value determined in the determining step, based on predetermined exhaust-gas-temperature values;
comparing the theoretical value of the exhaust-gas temperature with a limit value of the exhaust-gas temperature; and
if the theoretical value of the exhaust-gas temperature is lower than or equal to the limit value of the exhaust-gas temperature, transmitting the current optimized DT_{flex} value in the transmitting step; and
if the theoretical value of the exhaust-gas temperature is higher than the limit value of the exhaust-gas temperature, transmitting the DT_{flex} value for which the theoretical value of the exhaust-gas temperature is equal to the limit value of the exhaust-gas temperature as current optimized DT_{flex} value in the transmitting step.

6. The method of claim 1, comprising a measuring step, implemented before the acquiring step, for measuring the current values of the input parameters and for transmitting the current values of the input parameters to the avionic computer.

7. A device for optimizing a climb phase of an aircraft for determining an optimized DT_{flex} value corresponding to a temperature differential used to control thrust of the aircraft, comprising at least one avionic computer configured to:
acquire current values of input parameters including at least a weight of the aircraft, a speed of the aircraft, an altitude of the aircraft and a reference temperature;
determine a current optimized DT_{flex} value from the current values of the input parameters acquired in the acquiring step and from optimized DT_{flex} values recorded in a database integrated into the avionic computer, the database having been created beforehand by associating an optimized DT_{flex} value with each combination of input parameters for a predefined number of combinations of input parameters; and
transmit the current optimized DT_{flex} value determined in the determining step to a user system capable of using the current optimized DT_{flex} value to control the thrust of the aircraft.
